(19) United States
(12) Patent Application Publication
(10) Pub. No.: US 2009/0057098 A1
(43) Pub. Date: Mar. 5, 2009

(54) ARTICLE DISTRIBUTION APPARATUS

(75) Inventor: Hjalmarsson Helgi, Kopavogur (IS)

Correspondence Address: BROOKS KUSHMAN P.C., 1000 TOWN CENTER, TWENTY-SECOND FLOOR, SOUTHFIELD, MI, 48075, US

(73) Assignee: VALKA EHF, Kopavogur (IS)

(21) Appl. No.: 12/161,862

(22) PCT Filed: Jan. 23, 2007
(86) PCT No.: PCT/IS07/00003

§ 371 Date: Jul. 23, 2008

Related U.S. Application Data
(60) Provisional application No. 60/816,135, filed on Jun. 23, 2006.

(30) Foreign Application Priority Data
Jan. 23, 2006 (IS) 8259

(51) Int. Cl. B65G 47/46; G06F 7/00

(52) U.S. Cl. 198/351; 700/230

(57) ABSTRACT

This invention relates to an article distribution apparatus for distributing a stream of conveyed food articles from a conveyor conveying the food articles to one or more receiving stations, where two or more receiving arms are used for successively receiving and displacing the food articles from the conveyor to the one or more receiving stations. In a receiving position the first receiving arm is arranged at the end of the conveyor and forms an extension of the conveyor and the conveying path of the food articles for receiving one or more of the food articles. After receiving one or more food articles from the conveyor the first receiving arm is moved from the receiving position to the one or more receiving stations, the receiving position subsequently being replaced by the second receiving arm for receiving one or more of the subsequent food articles.

### FIELD OF THE INVENTION

The present invention relates to an article distribution apparatus for distributing a stream of conveyed articles from a conveyor conveying the articles to one or more distribution positions. The present invention further relates to a method of distributing a stream of conveyed articles from a conveyor conveying the articles to one or more distribution positions.

### BACKGROUND OF THE INVENTION

In the last years, there has been much progress in the field of processing articles, e.g. various weighing and portioning techniques. An example of such technique is disclosed in EP 1226408 which discloses weighing and portioning techniques bases on grader technique. In this disclosure a transport equipment of a robotic type is used to displace the articles to be processed into one or more bins. The use of such robotic type of transport can be very ineffective if the articles comprise sticky articles such as fish or fish fillet. Furthermore, the articles are being conveyed at a high conveying speed, the robotic type of transport must be provided with an effective displacement mechanism in order to be capable of removing the articles effectively from the conveyor.

A common displacement mechanism used today and is implemented in many types of graders is “arms”, that are used to push or pull the product from conveyor into e.g. receiving bins. The problem associated to use such arms is that they can cause a very rough handling of the articles, which can result in lowering the economical profit of the article and it also causes the arrangement of the articles to be lost. For non-rigid delicate food products this can result in significant extra work later in the process as the articles will need to be manually rearranged. One example is after filleting or cutting of fish fillets and grading them with traditional grading equipment the arrangement of the pieces is lost and then manual labor is typically needed to arrange the pieces properly before they are individually e.g. quick frozen in a freezer, placed in a tray to be sold to consumers or any other process which needs a certain arrangement of the pieces.

Another type of a displacement mechanism is “diverter” or “re-grouper” (see http://www.simade.com/). This mechanism consists mainly of a conveyor as shown in FIG. 1 made up of rollers 140, wherein receiving plates 160 are mounted to these rollers and move with the rollers at the same conveying speed in the conveying direction as indicated by arrow 150. The receiving plates are adapted to receive articles 110 from an in-feed conveyor 100 and deliver them to receiving conveyors 190-210. As shown in the FIG. 1, the plates consist of number of bars 170, 180 or units that are attached together in a “smooth” and non-rigid way so that a non-rigid property between the bars 170, 180 is obtained. It follows that the receiving plates 160 have sufficient flexibility to follow the closed loop conveying path of the conveyor 130.

The principle of this mechanism is following: the articles 110 are received onto the receiving plate 160 that is, during the receiving process moving with the same conveying speed as the conveyor 130 (indicated by arrow 250). A moving mechanism that has one degree of freedom perpendicular to the conveying direction 150 then causes an side-wise advancement of each respective bars 170, 180 at a certain location. As shown in the figure, this side-wise displacement causes a distortion of the receiving plate 160. This side-wise displacement is continued until the receiving plate 160 has reached the conveying path 240 of the receiving conveyor 210.

One disadvantage of this displacement mechanism is that due to the limitations in the degrees of freedom of the receiving plates 16 the mechanism is very space demanding. As shown here, the number of receiving conveyors 190-210 is three. Clearly, the space required by this mechanism increases with the number receiving conveyors.

Another disadvantage is that since the receiving plates 160 are a part of the conveyor 130 and are moved with the same constant conveying speed during diverting the articles 110 between the receiving conveyors 190-210, the receiving conveyors 190-210 are enforced to run with the same constant conveying speed as indicated by the arrows 220-240 during the processing, especially if the conveyed articles are delicate food articles. Otherwise, the received articles will be deformed and be jammed together at the receiving conveyors 190-210.

Another disadvantage is that due to the deformation of the receiving plates 160 during the side-displacement, the initial arrangement of the articles can easily change so that the delivery of the articles at the receiving conveyors 190-210 will not be the same, i.e. the displacement of the articles is not preserved throughout the processing.

Another disadvantage is that if the conveyed articles is e.g. a fish fillet or other sticky like products, it is essential that the receiving conveyors 190-210 are moving with the same conveying speed 220-240 as the incoming receiving plates 160, i.e. the same conveying speed as conveyor 130, since otherwise the received articles will be wrinkled on the receiving conveyors 190-210.

Another disadvantage is that the receiving conveyors 190-210 must clearly be situated at the end of the conveyor 130 and in the same plane. The system as shown in FIG. 1 will therefore require a huge amount of processing area when there are many receiving locations.

### BRIEF DESCRIPTION OF THE INVENTION

The object of the present invention is to therefore to overcome the above mentioned disadvantages by providing a simplified but simultaneously highly effective article distribution apparatus that requires only a minimum amount of space and is very flexible with regard to distributing articles or part of articles to various types of distribution positions. A further object of the present invention is to enable a distribution of the articles or article parts to distribution positions than can have totally different roles, e.g. one distribution position can be container or a box, another can be a conveyor, a third can be a grader apparatus to make weight determined portions of special type of article parts (e.g. only tail parts), etc. According to one aspect, the present invention relates to an article distribution apparatus for distributing a stream of conveyed articles from a conveyor conveying the articles to one or more receiving stations, comprising:
a control system,
at least a first and a second receiving arms adapted to move in at least two degrees of freedom movement, the receiving arms being operated independently of the conveyor by the control system based on at least one operating parameter for successively receiving and displacing the articles from the conveyor to the one or more receiving stations,
   wherein in a receiving position the first receiving arm is arranged substantially at the end of the conveyor in a way that it forms an extension of the conveyor and the conveying path of the articles for receiving one or more of the articles,
   wherein after receiving one or more articles from the conveyor the first receiving arm is moved from the receiving position to the one or more receiving stations, the receiving position subsequently being replaced by the second receiving arm for receiving one or more of the subsequent articles.

In that way, the conveyed articles—which commonly would be non-rigid food products, can be removed from the conveyor to the one or more receiving stations in a very effective way, without damaging the articles in any way as well as there precise arrangement will be kept. Further, due to the two or more degrees of freedom movement, the receiving arms have very large movement capabilities. It follows that the receiving stations can be situated at various locations, i.e. not necessarily at the end of the conveyor. Also, since the receiving arms are operated independently of the conveyor, they be can e.g. pre-programmed to displace the articles which can consist of a number of pieces from the conveyor at a very high speed and then distribute these pieces at another lower speed at a single or multiple receiving stations; the greater that the speed difference is the higher number of receiving arms is needed. The one or more receiving stations that can have completely different roles, where the displacement speed of the receiving arms can be adapted to the receiving stations need, i.e. very slow, very fast etc. As an example, the receiving station can be and “end-station” such as box, container or the like where the received articles are placed into, or the receiving station can be a take-away conveyor. In the former case, the receiving arms could be adapted to move very slowly near the receiving station, whereas in the latter case they could be moving faster. Also, the receiving arms are suitable to hold one or more articles and distribute them to different receiver location, i.e. the receiving arms can be deliver the received articles to more than one receiving stations. As an example, if one receiving arm contains head, central and tail part of one fish, the receiving arm can be adapted to deliver these three articles to three different receiving stations. Also, this article distribution apparatus is especially suitable to receive and displace the articles delicate non-rigid food articles from the conveyor to the one or more receiving stations in a very gently manner without damaging the articles. Another important advantage of the present invention is that the arrangement of the articles that are during the receiving and displacing preserved. Furthermore, the articles in the present invention are only in contact with the conveyor that conveys the articles (the in-feed conveyor) and the receiving arms, which makes the cleaning of the apparatus much simpler, and reduces or even eliminates possible hygienic problems. Accordingly, the article can comprise one or more pieces of food articles, or e.g. a box, can, container or anything alike. Also, by the term stream of articles is meant a single or multiple streams of articles.

In an embodiment the receiving arms comprise rim units mounted to a moving system for moving the rim units between the receiving position and the receiving stations, the rim units comprising a number of parallel and outwardly extending rods.

It can be of particular advantage using such rim units when the receiving stations comprise a rim-scale, which could be a part of another food processing apparatus, e.g. a grader. Accordingly, the received articles could be removed from the rim units simple by letting the rim units move through the rim-scale from above leaving at least a part of the received articles on the rim-scale. Another advantage of using such rim units is when the receiving stations comprise a conveyor which consists of multiple cords. Accordingly, the received articles could be removed from the rim units simple by letting the rim units move into the conveyor between the cords from above leaving at least a part of the received articles on the conveyor.

In an embodiment the rim units are during the receiving of the articles from the conveyor onto the rim units arranged partly below the conveyor and the conveyed articles, wherein during the receiving the moving system causes the rim units to move parallel to the conveying direction until one or more of the articles have been received by the receiving arms.

Thereby, it is ensured that the conveyed articles will at the end of the conveyor fall gently onto the rims. Also, by moving the rim units parallel to the conveying direction, preferably at a speed that is close to the conveying speed, it is prevented that the received articles will be wrinkled on the rim units. In the time between articles fall of the conveyor it is possible to move the rims faster forward than the conveyor such that more space is generated between the articles than was on the conveyor.

In an embodiment, the receiving arms further comprise a gripper unit to support the received articles on the receiving arms.

This is to ensure that the received articles will maintain their initial position and eventually prevents that the received articles become wrinkled on the receiving arms. The gripper unit can also assist in creating additional space between the articles on the receiver unit.

In an embodiment, the receiving arms comprise at least a first and a second receiving conveyors mounted to a moving system for moving the receiving conveyors as whole between the receiving position and the receiving stations.

In an embodiment, during receiving the articles from the conveyor onto the first receiving conveyor the first receiving conveyor is running in the same conveying direction as the conveyor until the one or more of the articles have been received, wherein subsequently the receiving conveyor is moved to the receiving stations.

It is thereby prevented that the received articles will be wrinkled on the rim units. The conveyor is preferably pre-programmed so that when noticing that when the article is being received it automatically runs in the direction parallel to the conveying direction of the articles, until the received article(s) has entered the conveyor. The time interval from where the receiving conveyor is run until it is stopped is of course selected so that the received article will stop on the receiving conveyor and will not exit the conveyor until at the receiving stations.

In an embodiment, during receiving the articles from the conveyor onto the first receiving conveyor the first receiving conveyor is running parallel to the conveying direction of the conveyor, or at any angle up to 90° in relation to the conveying direction of the conveyor. This can be beneficial when it is desired to arrange the articles at a certain angle into for example a receiving scale or a receiving conveyor.

In an embodiment, at the receiving stations the first receiving conveyor activates the conveyor in a direction towards the receiving stations until the received articles have been conveyed from the first receiving conveyor to the receiving stations.

In that way, the receiving conveyors have the possibility to be implemented as a kind of “in-feed” conveyors for the food processing techniques, e.g. grading etc. Also, the received articles can be removed from the receiving conveyors in a very gentle way.

In an embodiment, the moving system comprises a robot arm having at least two degrees of freedom.

Thereby, the movement of the rim units or the receiving conveyors is not necessarily limited to a certain path movement.

In an embodiment, the receiving arms are driven independently around one or more given paths from the receiving area through one or more receiving stations and then back to the receiving position.

In an embodiment, the at least one operating parameter comprises at least one parameter from the group of operating parameters consisting of:
the number of the receiving arms,
the time interval between two incoming and subsequent articles,
the number of receiving stations, and
the position of the receiving stations in relation to the receiving position.

In an embodiment, the apparatus further comprises a camera and an encoder interconnected to the control system, wherein the camera is adapted to detect the location of the articles on the conveyor and the encoder for tracing the detected location of the articles during the conveying.

In that way, the location of the articles can be traced very precisely. This can e.g. be used to determine the timing of activating the movement of the rims/receiving conveyors during the process of receiving the articles.

In an embodiment, the receiving arms are situated in between two or more conveyors.

Accordingly, the apparatus can be integrated into processing lines, thereby enhancing the variability of the apparatus.

In an embodiment, each of the receiver unit is attached to a driving wire that is driven by a driving motor and each of the receiver unit is attached to the wire via a connection unit, wherein the connection unit is adapted to adjust to connection to the driving wire and thereby simultaneously selected whether any desired receiver unit is fully stationary, moves at full speed with the wire or at any desired ratio of the full speed.

It follows that the receiver units can be waiting to enter the receiver location, and these would typically be fully stationary. In that way, a line up of receiver units can be formed which makes the apparatus more effective. A receiver unit which would be receiving articles would typically be moving at the same speed as the in-feed conveyor and during distribution the receiver units would typically run at the full speed of the driving wire which could be significantly faster than the speed of the in-feed conveyor.

According to another aspect, the present invention relates to a computer program product being adapted to enable a computer system comprising at least one computer having data storage means associated therewith to control the article distribution apparatus in accordance to any of the preceding claims.

According to yet another aspect, the present invention relates to a method of distributing a stream of conveyed articles from a conveyor conveying the articles to one or more receiving stations, comprising using at least a first and a second receiving arms adapted to move in at least two degrees of freedom movement and operated independently of the conveyor by a control system based on at least one operating parameter for successively receiving and displacing the articles from the conveyor to the one or more receiving stations,

wherein in a receiving position the first receiving arm is arranged substantially at the end of the conveyor in a way that it forms an extension of the conveyor and the conveying path of the articles for receiving one or more of the articles,

wherein after receiving one or more articles from the conveyor the first receiving arm is moved from the receiving position to the one or more receiving stations, the receiving position subsequently being replaced by the second receiving arm for receiving one or more of the subsequent articles.

Although it has been assumed throughout the description above that the system works to distribute a single stream of product it is easy to visualize that the system could work jointly on multiple streams of products but that would typically increase the number of receiving arms. Some benefit could be gained by integrating two streams onto a single system and one might be joint receiver station while another could be that a receiver unit could add more articles from the second or subsequent streams after having received one or more articles from the first stream before being translated to the receiver stations.

According to still another aspect, the present invention relates to a computer readable media adapted to store instructions for executing the above mentioned method steps.

It should, however, be noted that the invention can also be used for feeding, transporting and batching non-sticky products.

The aspects of the present invention may each be combined with any of the other aspects. These and other aspects of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a prior art displacement mechanism as described under the background of the invention,

FIG. 2 shows a perspective view of one embodiment of an article distribution apparatus according to the present invention,

FIG. 3 shows a side view of the article distribution apparatus from FIG. 2,

FIG. 4 shows a top view of the article distribution apparatus in FIGS. 2 and 3,

FIG. 5 shows a perspective view of another embodiment of an article distribution apparatus according to the present invention

FIG. 6 shows one embodiment of a method according to the present invention of distributing a stream of conveyed articles from a conveyor conveying the articles to one or more receiving stations.

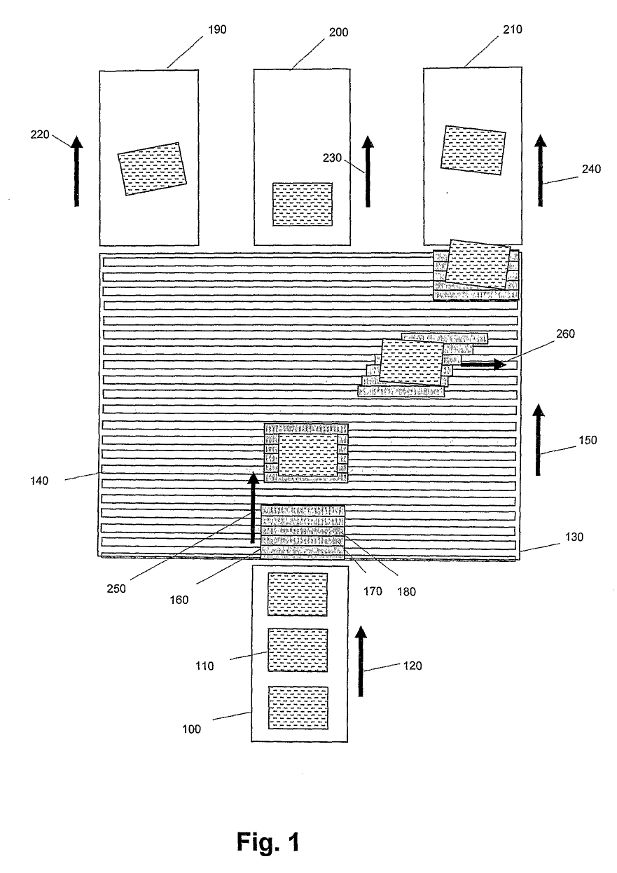

### DESCRIPTION OF EMBODIMENTS

The present invention relates to is a sorting or article distribution apparatus where at least a single stream of articles is selectively distributed into multiple streams or into multiple locations.

The concept is based on having multiple receiving arms which receive the articles from the stream, typically from the end of a conveyor. When the first receiving arm has received a desired number of articles that unit is moved away and another receiving arm starts receiving articles from the stream. The process of distributing the articles from the receiving arm can therefore take more time than the receiving process took. The more time difference there is, the more receiving arms are needed. Accordingly, the number of receiving arms can be increased from two to more than two receiving arms. After the receiving arm has been emptied it will be used again at the receiving location to receive more articles.

Another characteristic of the current invention is that the receiving arms can be moved rapidly while receiving the articles. This means that if more space is required between the articles than is on the in-feed conveyor then the receiving arm moves faster forward than the conveyor. The receiving arm can in some cases also move perpendicular to the conveyor and then the articles can be lined up properly on the receiver unit.

When the receiving arm has to move so rapidly that the articles already on the unit could move from there desired location it is possible to add a gripper unit (12) which will hold the articles in a fixed place on the receiver unit. This could be done by holding the articles with for example needles (13) which would be attached to an arm on the receiver unit. Another option would be to have anti-slip means on the receiver unit, e.g. rough surface, or have vacuum suction on the receiver unit.

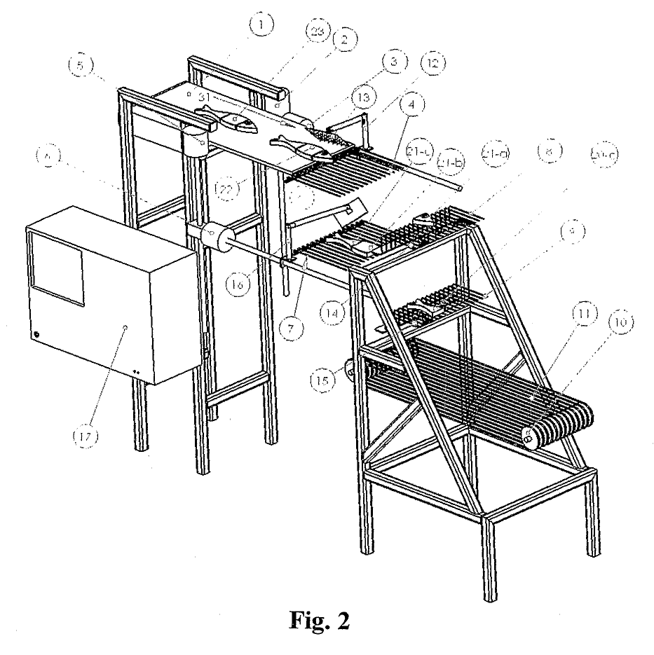

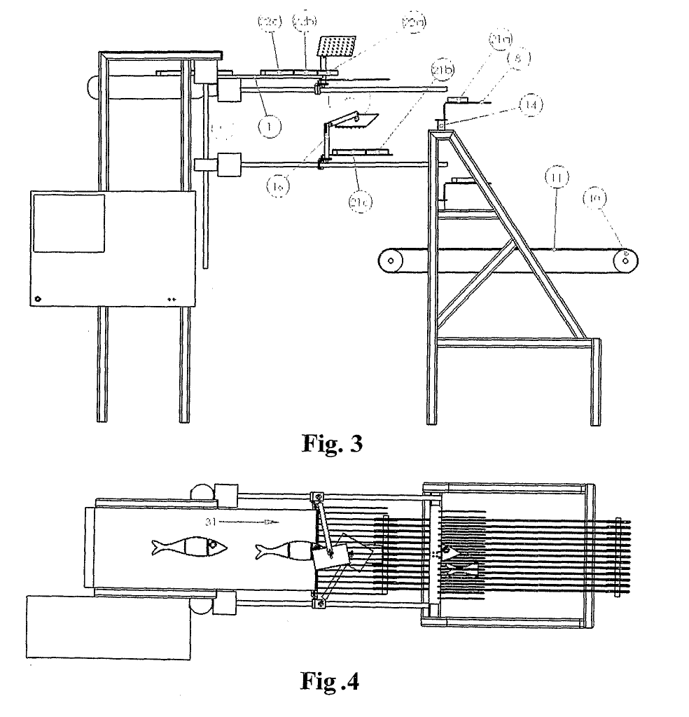

FIGS. 2-4 show a perspective view, a side view and a top view of one embodiment of an article (22, 23) distribution apparatus according to the present invention, showing where articles arrive on the in-feed conveyor (1). The article can e.g. comprise a fish, fish fillet, or a part thereof, e.g. a part of a fish fillet or a part of the fish. The article can further comprise any kind of food article, e.g. a piece of meat, a piece of poultry etc.

The articles (22, 23) could come from any process for example a portion cutting machine (not shown). Assuming that the articles are coming directly from a portion cutter the precise location of each article and its type will be known. In other applications where this information is not available a camera or a sensor (not shown) will be needed to record the precise location of the articles (22, 23). To keep track of the location on each article an encoder would typically be attached to the driving shaft of the in-feed conveyor. The sensing equipment, or for example the portion cutter (not shown), will need to transmit information regarding the articles to the control system (17) which controls the article receiver apparatus. When the article (22) has reached the end of the conveyor (1) one of the receiving arms (4) will be located with its front part at the end of the conveyor (1). To ensure that the article (22-a) will not fold or wrinkle on the receiver unit (4) it will be moved at the same speed as the conveyor (1). In this embodiment the receiver unit (4, 7) is a rim which is attached to a screw which can be rotated with a motor (3) which will result in a linear movement in the conveying direction (31) of the conveyor (1). That motor is then attached to another screw which can be rotated with a motor (2) which will result in a up or down movement of the rim (4). The same applies to the other receiving arm (7), it can be moved by the motors (5) or (6). If movement in the direction perpendicular to these two moving direction would be desired an additional motor could be used. When an article (e.g. 22a) has arrived on the rim unit (4) it can be ran faster than the conveyor such that a space is created between the articles on the rim. Once all the desired articles have been collected, e.g. in this type a whole fish which has been cut in three articles labeled, a, b and c, the rim is moved to the receiver location. In this case there are three receiver stations, 8, 9, 10 which are rim-scales such that the articles can be weighed before they are transferred to the next processing station and a conveyor which consist of separated cords. The rim scales are placed on load-cells, 14, 15 for static weighing of one or more of the articles before they transferred to further processing or packaging. The receiving stations could be of different type, e.g. other types of conveyors, boxes or trays of any kind and the articles could be pushed off the rim as well into any of the receiving stations. As can be seen on FIG. 2 the head (21-a) has been placed on rim-scale (8) while the other two articles of the fish still remain on the receiving rim (7). To release the desired number of articles from the receiving rim onto the a rim scale the receiving arm (4, 7) is moved directly above the rim-scale such that the overlapping length is exactly the same as the length of the article. Then the receiving arm (4, 7) is lowered down such that the rims on the receiver unit go between the rims on the scale and then the article will be transferred over to the rim-scale. The exact same process is used to release any number of pieces on the cord-conveyor and then the pieces will be located on the cords (11) ready to be conveyed to further processing or packing. Although there are only three receiving arms (4, 7, 10) shown in this example there can be any number of receiving arms. There are also only shown two receiving arms, rims, to receive the articles but they could be of arbitrary number as well. Here the receiver unit can move completely freely with two degrees of freedom; in general however there is no limit to how many degrees of freedom each receiver unit has.

The invention is not limited to having the receiving arms made of rims. They could be of any type for example conveyors (not shown) which would then either run in the same direction as the conveyor or perpendicular to the receiver unit or even under some angle if it is desired to place the articles under certain angle on for example a take-away conveyor.

On the receiver unit there can also be a gripper unit (12, 16) to support the articles (21a,b,c) on the unit. This can be practical when articles are received at a very high speed and it is needed to create space between the articles. Also if the receiver unit can move at a very high speed it could be necessary such that the articles will not get shifted or even fall off the receiver unit.

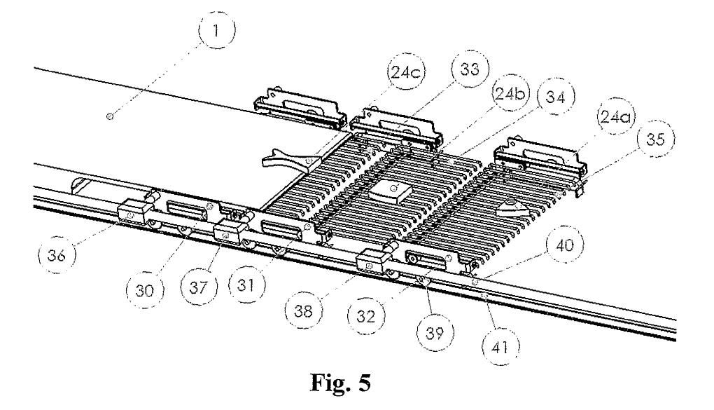

FIG. 5 shows another embodiment of the article distribution apparatus. Here the article receiver units 30, 31, 32 are driven in a cyclic path defined by the support structure 41 which also ensures at the same time that the receiver units are in the desired orientation throughout the cyclic movement. Here the receiver units have wheels 39 for support on the support structure. In this embodiment each receiver unit has a separate rim unit 33, 34, 35 which can move with respect to the receiver unit. In receiver units 30 and 31 the rim unit is in the forward position with respect to the moving direction, which would be the typical receiving position, while in receiver unit 32 the rim unit 35 is in the backward position. Any intermediate positions are also possible but there are means in the receiver units to ensure that the rim units are stable in the end positions. By placing the rim unit 35 in the backward position would typically mean that the upcoming receiver location (not shown on figure) would be passed and the article 24a would be released to any of the subsequent receiver location. The driving wire 40 is driven by a motor (not shown on figure) and each receiver unit is attached to the wire with a connection unit 36, 37, 38. This unit is made in such away that it can be selected whether any desired receiver unit is fully stationary, moves at full speed with the wire or at any desired ratio of the full speed. Receiver units which would be waiting to enter the receiver location would typically be fully stationary. A receiver unit 30 which would be receiving articles 24c would typically be moving at the same speed as the in-feed conveyor 1 and during distribution the receiver units 31, 32 would typically run at the full speed of the driving wire which would typically be significantly faster than the speed of the in-feed conveyor.

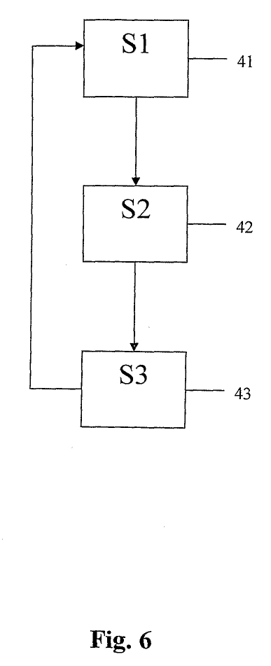

FIG. 6 shows one embodiment of a method according to the present invention of distributing a stream of conveyed articles from a conveyor conveying the articles to one or more receiving stations using at least a first and a second receiving arms operated by a control system based on at least one operating parameter.

A first receiving arm (S1) 41 is placed in receiving position at the end of the conveyor so that it forms an extension of the conveyor and the conveying path of the articles for receiving one or more of the articles.

After receiving one or more articles the first receiving arm is moved from the receiving position to the one or more receiving stations (S2) 42.

The receiving position of the first receiving arm is then replaced by a second receiving arm (S3) 43, where the subsequent articles are received.

The number of receiving arm is preferably adapted to e.g. how dense the distributing a stream of conveyed articles and the conveying speed, the number of receiving stations, the distance between the receiving stations in relation to the receiving position. Accordingly, the number of receiving arms is two or more.

Steps (S1)-(S3) are then repeated for the subsequent receiving arms.

Although the present invention has been described in connection with preferred embodiments, it is not intended to be limited to the specific form set forth herein. Rather, the scope of the present invention is limited only by the accompanying claims.

Certain specific details of the disclosed embodiment are set forth for purposes of explanation rather than limitation, so as to provide a clear and thorough understanding of the present invention. However, it should be understood by those skilled in this art, that the present invention might be practiced in other embodiments that do not conform exactly to the details set forth herein, without departing significantly from the spirit and scope of this disclosure. Further, in this context, and for the purposes of brevity and clarity, detailed descriptions of well-known apparatuses, circuits and methodologies have been omitted so as to avoid unnecessary detail and possible confusion.

Reference signs are included in the claims, however the inclusion of the reference signs is only for clarity reasons and should not be construed as limiting the scope of the claims.

1. An article distribution apparatus for distributing a stream of conveyed food articles from a conveyor conveying the food articles to one or more receiving stations, comprising:
a control system,
at least a first and a second receiving arms adapted to move in at least two degrees of freedom movement, the receiving arms being operated independently of the conveyor by the control system based on at least one operating parameter for successively receiving and displacing the food articles from the conveyor to the one or more receiving stations,
wherein in a receiving position the first receiving arm is arranged substantially at the end of the conveyor in a way that it forms an extension of the conveyor and the conveying path of the food articles for receiving one or more of the food articles,
wherein after receiving one or more food articles from the conveyor the first receiving arm is moved from the receiving position to the one or more receiving stations, the receiving position subsequently being replaced by the second receiving arm for receiving one or more of the subsequent food articles.

2. An apparatus according to claim 1, wherein the receiving arms comprise rim units mounted to a moving system for moving the rim units between the receiving position and the receiving stations, the rim units comprising a number of parallel and outwardly extending rods.

3. An apparatus according to claim 2, wherein the rim units are during the receiving of the food articles from the conveyor onto the rim units arranged partly below the conveyor and the conveyed food articles, wherein during the receiving the moving system causes the rim units to move parallel to the conveying direction until one or more of the food articles have been received by the receiving arms.

4. An apparatus according to claim 1, wherein the receiving arms further comprise a gripper unit to support the received food articles on the receiving arms.

5. An apparatus according to claim 1, wherein the receiving arms comprise at least a first and a second receiving conveyors mounted to a moving system for moving the receiving conveyors as whole between the receiving position and the receiving stations.

6. An apparatus according to claim 5, wherein during receiving the food articles from the conveyor onto the first receiving conveyor the first receiving conveyor is running in the same conveying direction as the conveyor until the one or more of the articles have been received, wherein subsequently the receiving conveyor is moved to the receiving stations.

7. An apparatus according to claim 1, wherein during receiving the food articles from the conveyor onto the first receiving conveyor the first receiving conveyor is running parallel to the conveying direction of the conveyor, or at any angle up to 90° in relation to the conveying direction of the conveyor.

8. An apparatus according to claim 1, wherein at the receiving stations the first receiving conveyor activates the conveyor in a direction towards the receiving stations until the received food articles have been conveyed from the first receiving conveyor to the receiving stations.

9. An apparatus according to claim 2, wherein the moving system comprises a robot arm having at least two degrees of freedom.

10. An apparatus according to claim 1, wherein the receiving arms are driven independently around one or more given paths from the receiving position through one or more receiving stations and then back to the receiving position.

11. An apparatus according to claim 1, wherein the at least one operating parameter comprises at least one parameter from the group of operating parameters consisting of:
the number of the receiving arms,
the time interval between two incoming and subsequent food articles,
the number of receiving stations, and
the position of the receiving stations in relation to the receiving position.

12. An apparatus according to claim 1, further comprising a camera and an encoder interconnected to the control system, wherein the camera is adapted to detect the location of the food articles on the conveyor and the encoder for tracing the detected location of the food articles during the conveying.

13. An apparatus according to claim 1, wherein the receiving arms are situated in between two or more conveyors.

14. An apparatus according to claim 1, wherein each of the receiver unit is attached to a driving wire that is driven by a driving motor and each of the receiver unit is attached to the wire via a connection unit, wherein the connection unit is adapted to adjust to connection to the driving wire and thereby simultaneously selected whether any desired receiver unit is fully stationary, moves at full speed with the wire or at any desired ratio of the full speed.

15. A computer program product being adapted to enable a computer system comprising at least one computer having data storage means associated therewith to control the article distribution apparatus in accordance to claim 1.

16. A method of distributing a stream of conveyed food articles from a conveyor conveying the food articles to one or more receiving stations, comprising using at least a first and a second receiving arms adapted to move in at least two degrees of freedom movement and operated independently of the conveyor by a control system based on at least one operating parameter for successively receiving and displacing the food articles from the conveyor to the one or more receiving stations,
wherein in a receiving position the first receiving arm is arranged substantially at the end of the conveyor in a way that it forms an extension of the conveyor and the conveying path of the food articles for receiving one or more of the food articles,
wherein after receiving one or more food articles from the conveyor the first receiving arm is moved from the receiving position to the one or more receiving stations, the receiving position subsequently being replaced by the second receiving arm for receiving one or more of the subsequent food articles.

17. A computer readable media adapted to store instructions for executing the method steps in accordance to claim 16.
